(19) United States
(12) Patent Application Publication
(10) Pub. No.: US 2021/0194370 A1
(43) Pub. Date: Jun. 24, 2021

(54) DC to DC converter module and method of control for the same

(71) Applicant: L7 Drive Oy, Karjalohja (FI)

(72) Inventor: Daniel Salonen, Karjalohja (FI)

(21) Appl. No.: 16/757,776

(22) PCT Filed: Oct. 23, 2018
(86) PCT No.: PCT/FI2018/050775

§ 371 Date: Apr. 21, 2020

(30) Foreign Application Priority Data
Oct. 23, 2017 (FI) 20175938

(51) Int. Cl. H02M 3/158

(52) U.S. Cl. CPC H02M 3/1584; H02M 2003/1586; H02M 3/1582

(57) ABSTRACT

According to an example aspect of the present invention, there is provided a Direct Current (DC) to DC converter module having a plurality of DC to DC converters connected in parallel and control circuitry connected to the DC to DC converters, said control circuitry configured to control operation of the DC to DC converters based on a duty cycle of the DC to DC converters.

### BACKGROUND

As discussed within Finnish Patent Application 20175422, a DC to DC converter module may be employed to raise a DC voltage on demand for supply to an electric motor. Typically the source voltage for such a module is very low, many times less than 10 volts and often less than 5 volts. In order for such a low voltage to provide sufficient power to drive the electric motors employed in vehicles and other applications, high currents are necessary.

These high currents are present in both the DC to DC converter module and any other intermediate circuitry used to drive the motor such as a motor drive. Both motor drives and electric motors themselves are sensitive to quick changes in input current. For example, due to the inductive nature of electronic motors, losses are greatly increased when input current fluctuates. Additionally, strong electromagnetic fields may cause damage within the motor, or indeed the drive and converters connected to the motor. Furthermore, fluctuations in current cause increased losses throughout connected electronics and may cause electromagnetic interference. These issues may even lead to problems during the certification processes of certain vehicles.

When a DC to DC converter operates, that is within a single buck or boost cycle, the fluctuation of the input current is from 0-100% without any reactive elements employed to smooth current flow, such as capacitors. For example if the converter converts 5V input voltage to 10V output the duty cycle is as follows. It charges energy to the inductor ⅔ of the cycle time and releases it on the remaining ⅓ of time. While releasing current stored in the inductor the current draw from the battery is around 0. Within many applications this gap is reduced by employing capacitors.

Within traditional DC to DC converter modules, the input and output currents through the module fluctuate for various reasons in addition to reasons outlined above. The ramp on and ramp off times of the components within the module may also introduce variance in the currents. For example, switches employed within a DC to DC converter module may take time to fully open and close and thus cause a variable current. Therefore, within traditional converter modules, the input and output currents are smoothed by providing a large capacitance in parallel to the input and output of the modules. However, given the high current and large power draw experienced in many applications, the capacitance necessary is quite large and thus many large and expensive capacitors are necessary. These capacitors not only increase the costs associated with employing the standard DC to DC converter module, but they also increase the size and weight of the DC to DC converter module. Further, the capacitors introduce losses and thus decrease the efficiency of the module. Tests on standard modules have shown that the capacitors necessary to smooth the current are the largest source of losses within a standard DC to DC converter module.

As seen in FIGS. 1A and 1B, a capacitor is employed between a standard energy source and, in this instance, a motor drive. During operation of the motor drive, the input current demands of the drive will vary. Within FIG. 1B an example, exaggerated, voltage across the capacitor (V_{S}) is shown with increased variance. Often, especially when a battery is employed as the energy source the voltage will remain relatively stable, however, for illustration purposes the top waveform of FIG. 1B, illustrates an output voltage Vₛ which varies periodically. When the current draw from the motor drive increases beyond what the battery can provide the output voltage falls below the voltage of the capacitor, the capacitor begins to discharge and maintain a voltage higher than the varying output voltage as illustrated by the red line of the second waveform of FIG. 1B. As follows, the load connected to such an energy source, in the instance of FIG. 1A a motor drive, experiences a fluctuating input current as shown by the last waveform of FIG. 1B. Capacitors are employed as shown in FIG. 1A not only to avoid losses as discussed above but also damages to the energy source, such as a battery which could be damaged by large fluctuations in current draw. This same concept is employed on the output side of the motor drive where even larger fluctuations in supplied current are balanced with capacitive elements.

As shown, standard DC to DC converter modules output a fluctuating current which is not ideal for use in electric motor applications. This fluctuating current is typically smoothed by use of capacitors which are costly and increase both the size and weight of the standard converter module.

### SUMMARY OF THE INVENTION

In order to increase efficiencies in both operation and production, the operations of a plurality of DC to DC converters within a DC to DC converter module are controlled in order to minimize fluctuations in input and output current. This is made possible by independently controlling individual DC to DC converters of the DC to DC converter module such that their outputs are staggered.

The invention is defined by the features of the independent claims. Some specific embodiments are defined in the dependent claims.

According to a first aspect of the present invention, there is provided a Direct Current (DC) to DC converter module comprising: a plurality of DC to DC converters; and control circuitry connected to the DC to DC converters and configured to control operation of the DC to DC converters individually. The control circuitry is configured to control operation of the DC to DC converters individually such that switching operations of the DC to DC converters are asynchronous.

According to a second aspect of the present invention, there is provided a method for controlling the operation of a DC to DC converter module having a plurality of DC to DC converters, said method comprising controlling operation of the DC to DC converters individually such that switching operations of the DC to DC converters are asynchronous.

### BRIEF DESCRIPTION OF THE DRAWINGS

FIGS. 1A and 1B illustrate a standard implementation of a filter capacitor between an energy source and a motor drive or DC to DC converter.

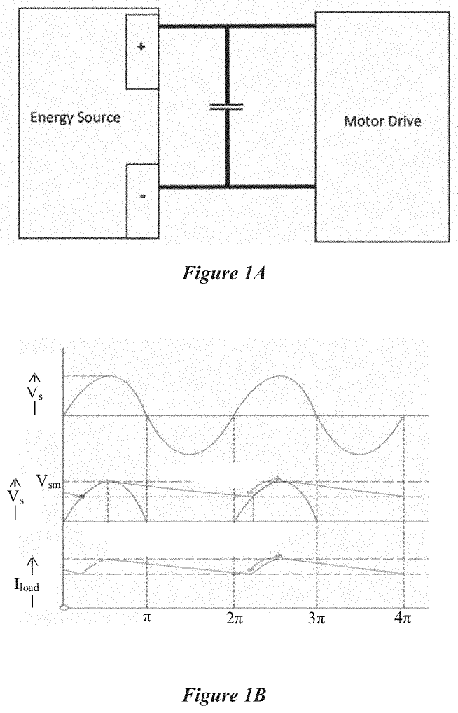

FIGS. 2A and 2B show input current waveforms for a single DC to DC converter (2A) and a DC to DC converter module having four dc to dc converters operating in a synchronous fashion (2B).

FIG. 3 illustrates input currents for individual DC to DC converters and the total input current for a DC to DC converter module containing the converters in accordance with at least some embodiments of the present invention;

FIG. 4 illustrates an example DC to DC converter module according to at least one embodiment of the present invention.

FIGS. 5A and 5B show output current waveforms for four DC to DC converters (A-D) of a DC to DC converter module and the total output current of the module when the DC to DC converters are operated in a synchronous (5A) and asynchronous (5B) fashion.

FIG. 6 illustrates an example DC to DC converter module according to at least one embodiment of the present invention.

### EMBODIMENTS

Definitions

In the present context, the term operating or switching cycle refers to the time a DC to DC converter spends in an off state plus the time the converter spends in an on state during a periodic cycle. For example, within a Buck Boost converter the time in an on state is Duty Cycle times Switching Cycle or T_{ON}=D×T_{S}.

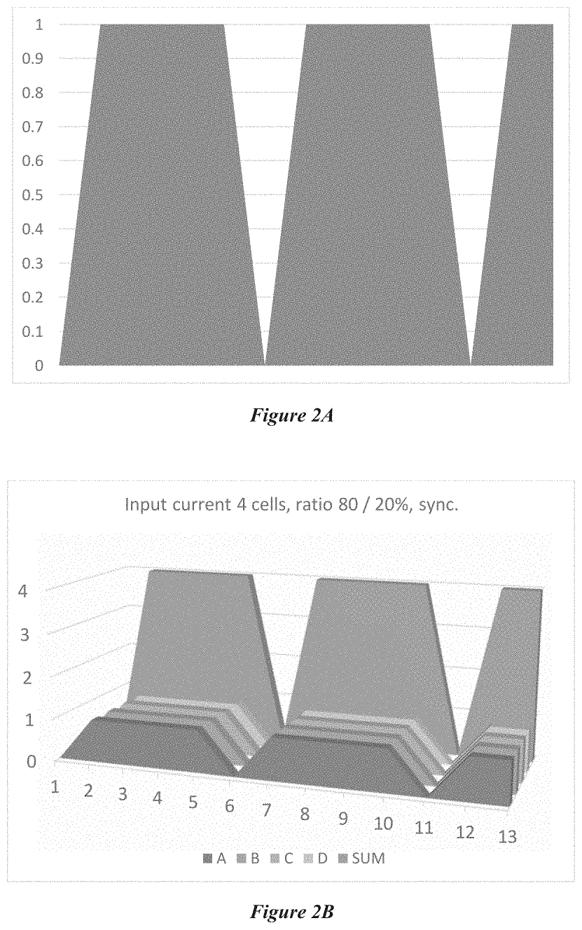

As seen in FIG. 2A, when only a single DC to DC converter is employed, in this instance a Buck-boost converter operating at an 80% duty cycle, the input current varies wildly without any smoothing capacitors. As seen in FIG. 2B this effect is amplified in a DC to DC converter module having multiple DC to DC converters. The input current experienced at four converters: A, B, C and D and summation of all input currents, SUM is shown within FIG. 2B. As illustrated, when multiple DC to DC converters are employed and controlled as a group in a synchronous fashion the current fluctuation is multiplied as a function of the number of DC to DC converters. FIGS. 2A and 2B do not show the impact of inductance nor capacitance for sake of illustration.

However, within DC to DC converter modules having a plurality of converters according to the present invention it is possible to independently control the switching of the converters and thus arrive at a more stable input and output current.

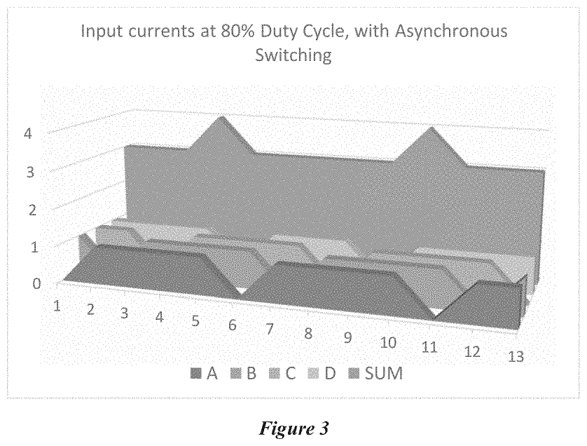

Within certain embodiments of the present invention a DC to DC converter module is provided having a plurality of independently controlled DC to DC converters. The switching components of each DC to DC converter are controlled such that the overall input and output current is as smooth as possible. For example, the input currents of four DC to DC converters employed within a DC to DC converter module according to the present invention are shown within FIG. 3. As shown, the switching of converters A-D are controlled such that no two converters are switching on at the same time. This results in an overall smoother total input current as illustrated by the SUM of the input currents of converters A-D. As seen, the input current never drops below a certain minimum level and only peaks briefly twice as compared to the greater variance shown in the input current of a single converter module shown in FIG. 2A.

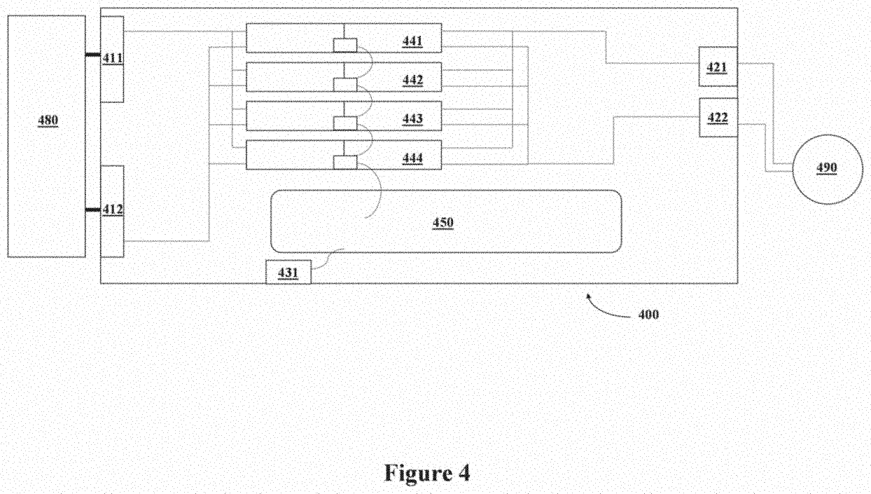

FIG. 4 illustrates a DC to DC converter module 400 according to at least some embodiments of the present invention. The DC to DC converter module 400 illustrated is placed between an electric power source 480 and electric motor 490, however the converter module may find use in a variety of applications. The DC to DC converter module 400 comprises a plurality of DC to DC converters 441-444; input terminals 411, 412; output terminals 421, 422; and control circuitry 450 having an input 431 for receiving a signal indicative of a desired electric motor performance or a desired output voltage. Within certain embodiments of the present invention this input signal is eliminated if a fixed conversion ratio is desired. Alternatively, certain embodiments employ a signal which is directly indicative of a desire DC to DC conversion. The control circuitry 450 of the DC to DC converter module is configured to control the DC to DC converters 441-444 independently such that changes in the overall input and output are minimized, for example, fluctuations in the output current are minimized.

DC to DC converter modules according to at least some embodiments of the present invention comprise a plurality of DC to DC converters and control circuitry connected to the DC to DC converters configured to control operation of the DC to DC converters individually. The control circuitry is configured to control operation of the DC to DC converters individually such that switching operations of the DC to DC converters are asynchronous. Within certain embodiments the control circuitry is configured such that there are two discrete times at which DC to DC converters are switched on.

Certain DC to DC converter modules according to the present invention comprise at least four DC to DC converters, preferably eight DC to DC converters and more preferably 16 DC to DC converters. This is based on the design parameters of the DC to DC converter module. The asynchronous control of sixteen independent DC to DC converters allows for a very smooth current flow and eliminates the need for large filter capacitance. Similarly, modules having eight DC to DC converters provide for smoother current than those with four. However, four modules have been proven effective at minimizing or eliminating filter capacitors in at least some applications.

In certain embodiments of the present invention, the control circuitry is configured to control the firing of individual DC to DC converters independently such that the converters are ramping up at different times. For example, the triggering time of individual DC to DC converters duty cycle would be staggered such that they occur throughout the operating or switching cycle of the first converter. That is to say, given a switching cycle of T for the first converter, and a total of four converters within the module, the triggering times for the converters would be at 0T, ¼T, 2/4T and ¾T. The output of such a control scheme or firing sequence is illustrated in FIG. 3 of the present application wherein converter A fires at time 0T, converter B at ¼T, converter C at 2/4T and converter D at ¾T. As can be seen, at point 4/4T, the firing sequence starts again with converter A. Within embodiments of the present invention with a greater number of converters, the firing sequence is determined in the same fashion. For example, in converter modules with six converters, the time between converter firings is T/6, in modules with 20 converters, the time between firings is T/20 or T/10 if converters are firing in pairs.

As discussed above, certain DC to DC converter modules according to the present invention have control circuitry which is configured to cause asynchronous operation of the DC to DC converters such that the times at which individual DC to DC converters are switched are evenly spaced throughout an operating or switching cycle of one of the DC to DC converters.

There are a variety of configurations of control circuitry for causing asynchronous operation of the DC to DC converters of DC to DC converter modules according to the present invention. Some DC to DC converter modules have control circuitry which is configured to cause asynchronous operation of the DC to DC converters such that no two DC to DC converters are switched at the same time. Certain modules have control circuitry which is configured to cause asynchronous operation of the DC to DC converters such that no two DC to DC converters are switched to an on state at the same time. At least some modules have control circuitry which is configured to cause asynchronous operation of the DC to DC converters such that no two DC to DC converters are switched to an off state at the same time.

At least some DC to DC converter modules of the present invention contain control circuitry which is configured such that the switching operations of the DC to DC converters are evenly distributed between a number of discrete switching times. Certain modules have control circuitry wherein the number of switching times is equal to the inverse of a duty cycle of one of the DC to DC converters, said inverse being rounded up to the next highest integer if the inverse is not an integer.

Within certain DC to DC converter modules according to the present invention two phases of voltage conversion are employed using two banks of DC to DC converter modules. A first bank of DC to DC converter modules first raises the input voltage to an intermediate voltage, this intermediate voltage is then raised by the second bank of DC to DC converter modules to arrive at a desired output voltage. Such a scheme of multiple banks of DC to DC converter modules proves especially useful when an input voltage is to be increased by greater than a factor of 8. Above an eight times increase the efficiency of the converter modules decreases drastically. Banks of DC to DC converter modules and configurations of DC to DC converters which may employ aspects of the present invention in order to increase efficiency and reduce production costs are discussed in greater detail within Finnish Patent Application 20175422.

DC to DC converter modules according to embodiments of the present invention have DC to DC converters which are configured to, in conjunction with the control circuitry, convert an input voltage to a higher output voltage.

Within at least some embodiments of the present invention the control circuitry is configured to measure each DC to DC converters state and present output in order to better control the DC to DC converters individually. This allows for a variety of control schemes.

Certain DC to DC converter modules according to the present invention employ DC to DC converters each having an individual controller. That controller operates its associated DC to DC converter in conjunction with a central controller also known as a systems level control or processing unit. This allows for greater flexibility when operating the DC to DC converter module, for example, if an individual converter is overheating or is failing, the controller associated with that converter may deactivate the converter and report to the central controller. The central controller can then alter the duty cycle of all other controllers so that they cover the gap the broken one has left in the current pattern. This same scheme could also be achieved using a central controller configured to monitor and control each converter individually.

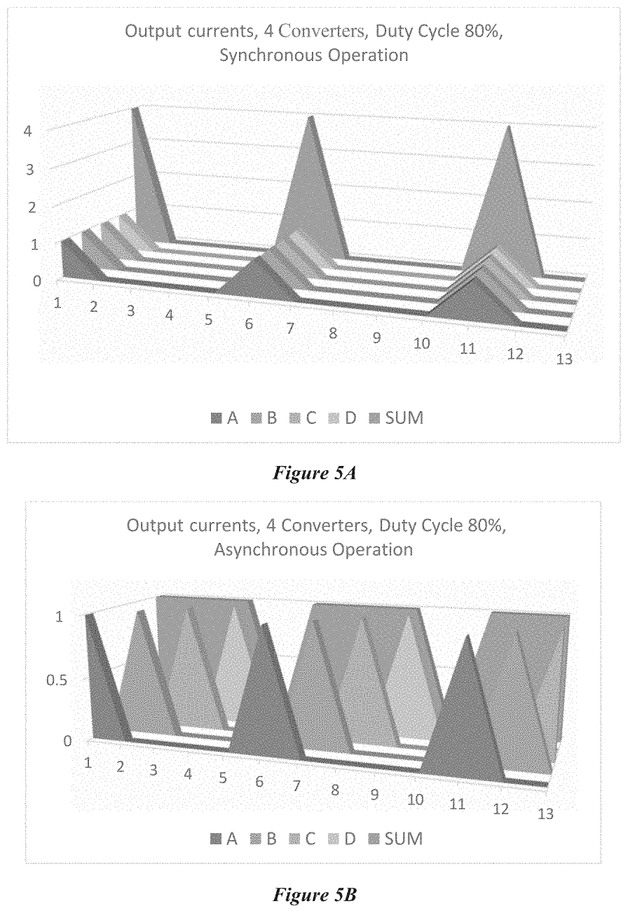

FIGS. 5A and 5B illustrate output currents for DC to DC converter modules having a plurality of DC to DC converters operated synchronously, FIG. 5A and asynchronously according to the present invention, FIG. 5B. As shown by the output current waveforms of FIGS. 5A and 5B, DC to DC converter modules according to the present invention provide for benefits both on the input current and output current side. Not only are energy sources less taxed, but connected loads receive a more consistent input current. As seen in FIG. 5A, the output current of the DC to DC converter is inverted compared to the input current as shown in FIG. 2B, this means that capacitive filtration is often even more critical on the secondary or output side of a DC to DC converter. Further, the output current of a module having multiple synchronously operated DC to DC converters is even more variable than the input current. However, when a control scheme according to the present invention is employed as in FIG. 5B, the overall output current is more consistent. Therefore capacitive support typically employed to smooth the current flow through a standard DC to DC converter is diminished if not eliminated.

At least some DC to DC converter modules according to the present invention employ bidirectional converters. That is to say the DC to DC converter module may be used to smooth current flow from or too an energy source. For example, certain batteries are ill adapted for use with fluctuating current, a DC to DC converter module according to the present invention would ensure that the charging current for such a battery is stable.

Within at least some embodiments of the present invention, for example DC to DC converter modules employing a plurality of buck-boost converters, it has been determined that a minimum of four converters is preferable to ensure a smooth output current. In embodiments with at least four converters it has been shown that the capacitance necessary for filtration may be reduced by up to 80% if not eliminated entirely.

Certain embodiments require each DC to DC converter to have their own control device. Other embodiments contain a plurality of control devices each controlling a plurality of converters independently. Said control devices track the flow through the converter and if a potential overload is detected, control of the converter is adjusted to ensure that the converter is not damaged. Each control device is controlled by a central controller such as a L7 Drive which controls the operation of the whole assembly.

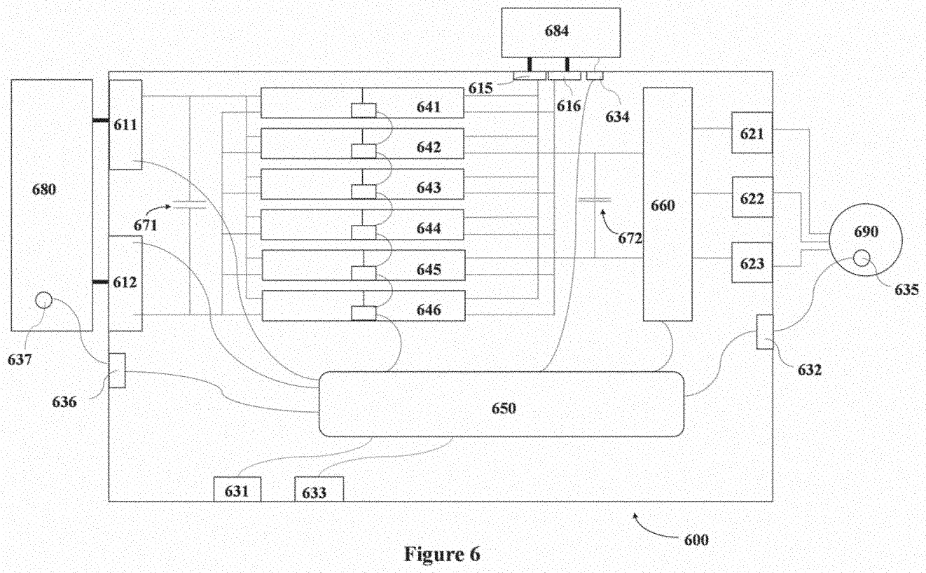

FIG. 6 illustrates a DC to DC converter module 600 according to at least some embodiments of the present invention. The converter module 600 may be used, as illustrated, between an electric power source 680 and electric motor 690. The DC to DC converter module 600 comprises a plurality of DC to DC converters 641-646; input terminals 611, 612; and control circuitry 650 having five inputs 631, 632, 633, 634, 636 for receiving signals from elements outside of the converter module 600. Signals indicative of a desired electric motor performance are received at 631 while signals indicative of the present motor performance are received at 632 as provided by an encoder 635 of the motor 690. Signals indicative of the present state of the electrical energy source 680, for example a temperature of the electrical energy source 680 are received at input 636 from sensor 637. Switches 660 are provided between the DC to DC converters 641-646 and the output terminals 621, 622, and 623. As discussed above, DC to DC converter modules according to the present invention diminished or even eliminate the need for filtering capacitors. However, capacitors 671 and 672 are illustrated within FIG. 6 to show where they would be installed in case it is necessary to smooth the input and output of the DC to DC converters.

Also illustrated in FIG. 6 are charging terminals 615 and 616. Certain embodiments of the present invention enable charging from an external electricity source 684, such as a charger connected to a wall socket or a battery, which is connected to the charging terminals. As shown the external electricity source 684 is connected such that external electric energy may be converted by the DC to DC converters 641-646 prior to recharging the connected energy source 680 or battery. In this fashion the DC to DC converters, controlled according to the present invention, insure a smooth charging current for a connected battery.

As can be seen, this independent control of a plurality of DC to DC converters provides many benefits. For example, certain embodiments of the present invention allow for the creation of a rotating field at the output of the converter module, for example a three phase rotating field as would be employed in an AC motor, brushless dc motor or switched reluctance motor. Also it is possible to create a rotating multi-phase field for a plurality of motors.

Certain DC to DC converter modules according to the present invention control operation of the DC to DC converters such that DC to DC converters are grouped based on a maximum duty cycle. Such modules may set a number of switching times equal to the number of DC to DC converters unless the number of converters divided by the inverse of the duty cycle is greater than or equal to two. At that point the DC to DC converters will be divided into groups equal to the truncated integer value resulting from the number of converters divided by the inverse of the duty cycle. For example, if there are 16 converters employed in a module and the duty cycle is set to be ⅛, the converters will be divided into pairs, each pair firing synchronously. However, if only 12 converters are employed and the desired duty cycle is ⅛, the result of the above calculation (12/8=1.5) the converters would not be grouped. Larger groups than pairs may be employed, for example, if the duty cycle desired is ¼ and there are 16 converters, the converters would be divided into 4 groups of 4, each group firing synchronously as 16/4=4.

In the above or another fashion certain DC to DC converter modules achieve asynchronous operation of groups of DC to DC converters. It should be understood that switching operations of DC to DC converters may be asynchronous according to the present application even when portions of the DC to DC converters are grouped to fire synchronously and groups fire asynchronously.

At least some embodiments of the present invention provide for a method for controlling the operation of a DC to DC converter module having a plurality of DC to DC converters, said method comprising the step of controlling operation of the DC to DC converters individually such that switching operations of the DC to DC converters are asynchronous. Within certain methods according to the present invention, there are at least two discrete times when DC to DC converters are switched on. Certain methods employing four DC to DC converters per modules ensure that there are four discrete times when DC to DC converters are switched on.

Within at least some DC to DC converter modules according to the present invention the load is balanced between the individual DC to DC converters. For example, the DC to DC converters operated equally in terms of duty cycle and power transferred.

Some methods according to the present invention are adapted to control DC to DC converter modules comprising at least four DC to DC converters, preferably eight DC to DC converters and more preferably 16 DC to DC converters.

There are a variety of methods for causing asynchronous operation of the DC to DC converters of DC to DC converter modules according to the present invention. Some methods cause asynchronous operation of the DC to DC converters such that no two DC to DC converters are switched at the same time. Certain methods cause asynchronous operation of the DC to DC converters such that no two DC to DC converters are switched to an on state at the same time. At least some methods cause asynchronous operation of the DC to DC converters such that no two DC to DC converters are switched to an off state at the same time.

Within at least some method according to the present invention switching operations of the DC to DC converters are evenly distributed between a number of discrete switching times. Within certain methods the number of switching times is equal to the inverse of a duty cycle of one of the DC to DC converters, said inverse being rounded up to the next highest integer if the inverse is not an integer. Through such methods an even input and output current is achieved.

As discussed above, certain methods according to the present invention have cause asynchronous operation of the DC to DC converters such that the times at which individual DC to DC converters are switched are evenly spaced throughout an operating or switching cycle of one of the DC to DC converters.

Within at least some methods according to the present invention, the DC to DC converter module is controlled to convert an input voltage to a higher output voltage.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### ACRONYMS LIST

DC Direct Current

### REFERENCE SIGNS LIST

400 DC to DC Converter Module

411, 412 Input Terminals

421, 422 Output Terminals

431 Input

441-444 DC to DC Converters

450 Control Circuitry

480 Electric Power Source

490 Electric Motor

600 DC to DC Converter Module

611, 612 Input Terminals

615, 616 Charging Terminals

621-623 Output Terminals

631-636 Inputs

635 Encoder

637 Sensor

641-646 DC to DC Converters

650 Control Circuitry

671, 672 Capacitors

680 Electric Power Source

690 Electric Motor

1. A Direct Current (DC) to DC converter module comprising:
a plurality of DC to DC converters connected in parallel; and
control circuitry connected to the DC to DC converters and configured to control operation of the DC to DC converters individually;
the control circuitry is configured to control operation of the DC to DC converters individually such that a number of switching operations of the DC to DC converters or time between switching operations of different DC to DC converters is adjusted based at least partly on a duty cycle of the DC to DC converters.

2. The DC to DC converter module according to claim 1, wherein the DC to DC converters each have the same duty cycle.

3. The DC to DC converter module according to claim 1, wherein the number of switching times equals the number of DC to DC converters unless the number of converters divided by the inverse of the duty cycle is greater than or equal to two at which point DC to DC converters will be configured to fire in groups.

4. The DC to DC converter module according to claim 1, wherein the control circuitry is configured such that there are at least two discrete times at which DC to DC converters are switched on.

5. The DC to DC converter module according to claim 1, wherein there are at least four DC to DC converters.

6. The DC to DC converter module according to claim 1, wherein the control circuitry is configured such that the switching operations of the DC to DC converters are evenly distributed between a number of discrete switching times.

7. The DC to DC converter module according to claim 6, wherein the number of switching times is equal to the inverse of the duty cycle, said inverse being rounded up to the next highest integer if the inverse is not an integer.

8. The DC to DC converter module according to claim 1, wherein the control circuitry is configured to cause asynchronous operation of the DC to DC converters such that no two DC to DC converters are switched to an off state at the same time.

9. The DC to DC converter module according to claim 1, wherein the control circuitry is configured to cause asynchronous operation of the DC to DC converters such that the times at which individual DC to DC converters are switched are evenly spaced throughout an operating cycle of one of the DC to DC converters.

10. The DC to DC converter module according to claim 1, wherein the DC to DC converters are configured to, in conjunction with the control circuitry, convert an input voltage to a higher output voltage.

11. A method for controlling the operation of a DC to DC converter module having a plurality of DC to DC converters connected in parallel, the method comprising:
controlling operation of the DC to DC converters individually such that time between switching operations of different DC to DC converters is adjusted based at least partly on a duty cycle of the DC to DC converters.

12. The method according to claim 11, wherein the DC to DC converters each have the same duty cycle.

13. The method according to claim 11, wherein the number of switching times equals the number of DC to DC converters unless the number of converters divided by the inverse of the duty cycle is greater than or equal to two at which point DC to DC converters will be configured to fire in groups.

14. The method according to claim 11, wherein switching operations of the DC to DC converters are evenly distributed between a number of discrete switching times.

15. The method according to claim 14, wherein the number of switching times is equal to the inverse of the duty cycle, said inverse being rounded up to the next highest integer if the inverse is not an integer.

16. The method according to claim 11, wherein the times at which individual DC to DC converters are switched are evenly spaced throughout an operating cycle of one of the DC to DC converters.

17. The method according to claim 11, wherein the DC to DC converter module is configured to convert an input voltage to a higher output voltage.

18. The method according to claim 11, wherein no two DC to DC converters are switched to an on state at the same time.

19. The method according to claim 11, wherein no two DC to DC converters are switched to an off state at the same time.

20. The method according to claim 11, wherein the times at which individual DC to DC converters are switched are evenly spaced throughout an operating cycle of one of the DC to DC converters.
